(19) United States
(12) Patent Application Publication
(10) Pub. No.: US 2011/0292208 A1
(43) Pub. Date: Dec. 1, 2011

(54) HIGH-RESOLUTION URBAN TRUE ORTHOIMAGE CREATION

(75) Inventors: Guoqing Zhou, Virginia Beach, VA (US); Wenhan Xie, Beijing (CN)

(73) Assignee: Old Dominion University Research Foundation, Norfolk, VA (US)

(21) Appl. No.: 12/952,896

(22) Filed: Nov. 23, 2010

Related U.S. Application Data
(60) Provisional application No. 61/281,885, filed on Nov. 24, 2009.

(51) Int. Cl. H04N 7/18; G06K 9/00

(52) U.S. Cl. 348/144; 382/100; 348/E07.085

(57) ABSTRACT

A method, system, and computer readable medium for producing orthoimages of the images of a (typically) high-resolution imager of an urban area, the orthoimages of high buildings being imaged with improved accuracy by increasing constraint conditions on the building edges, such as perpendicularity, collinearity. These constraint conditions are merged into an orthorectification model for orthorectifying the images captured at a predetermined elevation, whether by airborne or spaceborne. Constraint conditions may be formed by the building edge points, such as corners, and may be used with a digital building model. Thus, an aspect of embodiments is that the constraint conditions may be directly formed from the building themselves. The higher the buildings, the more effective the constraint controls.

### RELATED APPLICATIONS

This application claims the benefit under 35 USC 119(e) of U.S. Provisional Patent Application No. 61/281,885, filed Nov. 24, 2009, the entire disclosure of which is hereby incorporated by reference.

### STATEMENT REGARDING GOVERNMENT SUPPORT

This invention was made in part with government support under Grant No(s). 0131893, titled: “Urban True Orthophoto Generation and Its Standard Initiative—Phase II” and 0735879, titled: “National Large-Scale City True Orthophoto Mapping and Its Standard Initiative—Phase I,” awarded by the National Science Foundation.

### BACKGROUND OF THE INVENTION

1. Field of the Invention

The present invention relates generally to the correction of digital images or photographs, in particular, the orthorectifying of high-resolution digital images (such as 6 inch or one foot), acquired from an airborne and spaceborne imager, with improved accuracy in the correction of images of tall buildings in urban settings, using the buildings' geometric constraint control information.

The present invention has application to a variety of fields, such as geographic information systems (GIS), civil engineering, urban planning and design, terrestrial mapping, geoscience, geography, surveying, photogrammetry, and remote sensing.

2. Description of the Related Art

Digital orthophotos (also called orthoimages) are an important component of geospatial data, including that within the National Spatial Data Infrastructure (NSDI). For urban areas, particularly for very high buildings within urban areas, traditional methods have not been capable of orthorectifying the displacements caused by the height of such buildings.

The generation of so called ‘true’ orthoimages has been investigated by a number of researchers, such as those in the following references: F. Amhar, J. Josef, and C. Ries, “The generation of true orthophotos using a 3D building model in conjunction with a conventional DTM,” 4Int. Arch. Photogramm. Remote Sens., vol. 32, pp. 16-22, 1998; A. Biason, S. Dequal, and A. Lingua, “A new procedure for the automatic production of true orthophotos,” Int. Arch. Photogramm. Remote Sens. Spatial Inform. Sci., vol. 35, pp. 538-543, Jul. 12-23, 2004; A. F. Habib, E.-M. Kim, and C.-J. Kim, “New methodologies for true orthophoto generation,” Photogramm. Eng. Remote Sens., vol. 73, no. 1, pp. 25-36, 2006; W. Mayr, “Bemerkungen zum thema, true orthoimage,” in Photogrammetrie Fernerkundung Geoinformation, vol. 4, April 2002, pp. 237-244; M. Ø. Nielsen, “True orthophoto generation,” M.S. thesis, Inform. Math. Model., Tech. Univ. Denmark, Copenhagen, Denmark, 2004; V. Pala and R. Arbiol, “True orthoimagery of urban areas. Imagery free from visible walls and hidden areas,” GIM Int., vol. 16, no. 12, pp. 50-51, December 2002; J.-Y. Rau, N.-Y. Chen, and L.-C. Chen, “True orthophoto generation of built-up areas using multi-view images,” Photogramm. Eng. Remote Sens., vol. 68, no. 6, pp. 581-588, June 2002; Y. Sheng, P. Gong, and G. S. Biging, “True orthoimage production for forested areas from large-scale aerial photographs,” Photogramm. Eng. Remote Sens., vol. 69, no. 3, pp. 259-266, March 2003; S. Siachalou, “Urban orthoimage analysis generated from IKONOS data,” Int. Arch. Photogramm., Remote Sens. Spatial Inform. Sci., vol. XXXV, pp. 186-191, Jul. 12-23, 2004; Skarlatos, D. “Orthophotograph production in urban areas,” Photogrammetric Record, vol. 16, no. 94, pp. 643-650, 1999; Joshua, G., Evaluating the accuracy of digital orthophotos quadrangles (DOQ) in the context of parcel-based GIS, Photogrammetrlc Engineering & Remote Sensing, vol. 67, no. 2, pp. 199-205, 2001.; Schickler, W., and A. Thorpe. Operational procedure for automatic true orthophoto generation, International Archives of Photogrammetry and Remote Sensing, vol. 32, Part 4, pp. 527-532, (1998); Jauregui, M., J. Vilchez, and L. Chacón “A procedure for map updating using digital monoplotting.” Computers & Geosciences, 28(4): 513-523, (2002). Passini, R. and K. Jacobsen, “Accuracy Analysis of digital orthophotos from very height resolution imagery,” International archives of the photogrammery, remote sensing and spatial information sciences, edited by Orthan Altar', vol. XXXV, Jul. 12-23, 2004, DVD, 2004.

Additionally, the following literature is incorporated by reference in their entirety: W. Xie and G. Zhou, “Urban 3D building model applied to true orthoimage generation,” in Proc. 1st Workshop EARSeL Spec. Interest Group Urban Remote Sens., Berlin, Germany, Mar. 2-3, 2006. DVD; G. Zhou, W. Chen, J. A. Kelmelis, and D. Zhang, “A comprehensive study on urban true orthorectification,” IEEE Trans. Geosci. Remote Sens., vol. 43, no. 9, pp. 2138-2147, September 2005; G. Zhou and W. Chen, “Urban large-scale orthoimage standard for national orthophoto program,” in Proc. IEEE Geosci. Remote Sens. Annu. Conf., Seoul, Korea, Jul. 25-29, 2005, pp. 1214-1217; G. Zhou, K. Jezek, W. Wright, J. Rand, and J. Granger, “Orthorectification of 1960s satellite photographs covering greenland,” IEEE Trans. Geosci. Remote Sens., vol. 40, no. 6, pp. 1247-1259, June 2002.

Skarlatos (1999) and Joshua (2001) demonstrated that building occlusions did significantly influence not only image quality but also the accuracy of orthoimages. The authors in references F. Amhar (1998), Schickler and Thorpe (1998), and W. Mayr (2002) not only considered the hidden effects introduced by abrupt changes of surface height (e.g., buildings) but also the seamless mosaicking of images around fill-in areas in order to reduce gray-value discontinuities. Rau et al. (2002) in reference presented a suitable enhancement technique to restore information within building shadow areas. Jauregui et al. (2002) presented a procedure for orthorectifying aerial photographs to produce and update terrain surface maps. Passini and Jacobsen (2004) analyzed the accuracy of orthoimages from very high resolution imagery. Biason et al. (2004) in “A new procedure for the automatic production of true orthophotos,” further explored the automatic generation of true orthoimages. Zhou et al. (2005) in “A comprehensive study on urban true orthorectification,” comprehensively discussed the true orthoimage generation.

Conventional orthorectification often uses the photogrammetry differential model. For any given ground point, such as G, the mathematical expression is as follows:

$$\begin{matrix}{x}_{g} - {x}_{0} = - f \frac{{a}_{1} ( {X}_{G } - {X}_{S} ) + {b}_{1} ( {Y}_{G} - {Y}_{S} ) + {c}_{1} ( {Z}_{G} - {Z}_{S} )}{{a}_{3} ( {X}_{G } - {X}_{S} ) + {b}_{3} ( {Y}_{G} - {Y}_{S} ) + {c}_{3} ( {Z}_{G} - {Z}_{S} )} & ( 1 a ) \\ {y}_{g} - {y}_{0} = - f \frac{{a}_{2} ( {X}_{G } - {X}_{S} ) + {b}_{2} ( {Y}_{G} - {Y}_{S} ) + {c}_{2} ( {Z}_{G} - {Z}_{S} )}{{a}_{3} ( {X}_{G } - {X}_{S} ) + {b}_{3} ( {Y}_{G} - {Y}_{S} ) + {c}_{3} ( {Z}_{G} - {Z}_{S} )} & ( 1 b )\end{matrix}$$

where f, x₀, and y₀ are the camera's interior orientation parameters (or IOPs); X_{S}, Y_{S}, and Z_{S} are the positions of exposure station; a₁, . . . , c₃ are the elements of rotation matrix, which are functions of three rotation angles ω, φ, and κ; x_{g} and y_{g} are the image coordinates of the ground point G; and X_{G}, Y_{G}, and Z_{G} are the coordinates of the ground point G in the ground coordinate system.

Equation (1) can further be expressed by a vector equation after linearizing using Taylor's series, i.e.,

V=AT−L (2)

where T=(ψωκX_{S}Y_{S}Z_{S})^{T}, V=(υ_{gx1}υ_{gy1}υ_{gx2}υ_{gy2})^{T}, L=(l_{gx1}l_{gy1}l_{gx2}l_{gy2})^{T}, and A is a coefficient (see, e.g., E. Mikhail, et al. (2001)). With a number of ground control points (or GCPs), the nominal IOPs provided by the vendor can be calibrated, and the exterior orientation parameters (or EOPs) in equation (2) can be solved using least squares estimation. Once the IOPs and EOPs were determined, any ground point can be orthorectified onto a predefined orthogonal plane. Additional details of this process of orthorectification may be found in G. Zhou, et al. (2002).

In order to increase the accuracy of orthoimage, the number of GCPs may sometimes be increased, and/or well-distributed GCPs may be selected. This approach has its limitations because the location and distribution of GCPs impact the accuracy of orthorectification, while most of the current GCPs are distributed on the ground, which means that the top of a high building has no sufficient control information.

### SUMMARY OF THE INVENTION

The applicants have developed an innovative method and system which takes advantage of certain features, such as collinearity and perpendicularity of a building's edges, as constrain-control conditions to realize improved orthorectification. This approach radically differs from conventional methods, which use GCPs as control information.

The proposed method considers a building's geometric features, including the perpendicularity and collinearity of the building's edges, and then models these geometric features as a constraint condition. These modeled geometric features are merged into the orthorectification model.

Compared to the existing methods, the present method and system can largely increase the accuracy, and reduce the cost of orthophoto generation, since the invented method only needs a small number of GCPs, which traditionally cost a significant amount of money. An aspect of the present method and system is that they have little negative impacts caused by the height of the buildings, since the constraint controls are directly from the buildings themselves. The higher the buildings, the more effective the constraint controls.

Test results demonstrated that embodiments of the new approach can improve the accuracy from 2-5 feet for those buildings over 50 m high, and 5-7 feet for those buildings in the margin of imagery. An aspect of the new approach is that it has been shown to meet the requirements of the National Large Scale Orthophoto Standard of the National Geospatial Data Committee (NGDC). Thus, embodiments of the invention have been verified using international standard test methods, and will thus be conducive to the development of international products and services.

One embodiment is a computer readable medium, system, and method of orthorectification for tall buildings suitable for use with a digital building model, where a subject building is imaged aerially at a known or predetermined height above ground. The building constrain controls are constructed by corners at spatial locations on buildings and are projected onto the image so that the image of the building is able to be orthorectified at their correct upright position.

In another embodiment, orthorectification may include a digital terrain model based orthoimage generation. Briefly, the true orthoimage generation is composed of digital terrain-model (DTM)-based orthoimage generation, digital-building-model (DBM)-based orthoimage generation, and their merging. Some associated works for true orthoimage creation are the occlusion detection and refilling, shadow detection and compensation, and radiometric difference balance.

In another embodiment, the method, including algorithms and procedures (e.g., urban DMB, occlusion compensation, shadow removal, DTM based orthophoto, and true orthophoto, etc) may be implemented by a system having software and appropriate hardware for implementation of orthoimaging.

Another embodiment is a method of differential orthorectification of a high-resolution aerial image that is taken at a known height. An image or picture is taken of at least a portion of the target image that depicts at least one structure. The method selects at least two spatial locations on the portion of the image that depict at least that one structure. The spatial locations correspond to points on the structure in which edges of the structure are either perpendicular or collinear. The points form at least two geometric constraint controls based on two or more spatial locations using a digital building model and then applying the geometric constraint controls to the image in order to orthorectify the portion of the image depicting the structure into an upright and correct position.

Additionally a perpendicular geometric constraint control on the digital building model is expressed by C₁\hat{X}₁+W₁=0.

Further, a collinear geometric constraint control on the digital building model is expressed by C₂\hat{X}₂+W₂=0.

When the differential orthorectification is expressed by V=AT+B\hat{X}−L; a perpendicular geometric constraint control on the digital building model is expressed by C₁\hat{X}₁+W₁=0; and a collinear geometric constraint control on the digital building model is expressed by C₂\hat{X}₂+W₂=0; where

$$\{ \begin{matrix}δ X = - ( {Q}_{11} {D}^{T} L + {Q}_{12} {W}_{x} ) \\ {K}_{s} = - ( {Q}_{21} {D}^{T} L + {Q}_{22} {W}_{x} )\end{matrix}$$

and where:

$${( \begin{matrix}{N}_{dd} & {C}_{x}^{T} \\ {C}_{x} & 0\end{matrix} )}^{- 1} = ( \begin{matrix}{Q}_{11} & {Q}_{12} \\ {Q}_{21} & {Q}_{22}\end{matrix} ) .$$

In another embodiment is a system of orthorectification having an imaging device for acquiring at least one image from at least one predetermined and/or known elevation, where at least a portion of the image depicts at least one structure. The acquired image is retained in a memory or computer storage device as digital data. There is a processor in communication with the imaging device and the memory. Additionally, the memory hosts a database and software coupled with the processor for selecting at least two spatial locations on the portion of the image that depict the structure. The spatial locations correspond to points on the structure in which edges of the structure are either perpendicular or collinear. The spatial locations form at least two geometric constraint controls based on the at least two spatial locations. Using a digital building model and applying the at least two geometric constraint controls to the image the portion of the image is orthorectified into depicting the structure into an upright and correct position.

In yet another embodiment there is a computer readable medium storing a computer program product for orthorectifying a first image of at least one building having a plurality of corners using a plurality of images. The computer readable medium has a computer program code for receiving and storing data from an imaging device, the data representing the plurality of images.

There is a computer program code for selecting at least two corners at spatial locations on at least one building and a computer program code for forming geometric constraint controls based on the plurality of corners. A computer program code then applies a digital building model to orthorectify the first image with the building at an upright and correct position.

Thus, presented is a method for increasing the accuracy of high-resolution orthorectification for high buildings in urban area. An aspect of the method considers the building geometric features, including the perpendicularity and collinearity of building edges, and then models these geometric features as a constraint condition. These modeled geometric features are merged into the orthorectification model.

### DESCRIPTION OF THE DRAWINGS

FIG. 1A shows a completely orthorectified image of a building.

FIG. 1B shows a different accuracy for an incompletely orthorectified image for the same building as shown in FIG. 1A in two aerial images.

FIG. 2 illustrates geometry of the camera coordinate system for perpendicular constraint and collinear constraint conditions.

FIG. 3A shows part of original aerial images.

FIG. 3B shows DSM in downtown of Denver, Colo., in which the brightness in the DSM represents surface height.

FIG. 4A shows measures of ground control points as well as their image positions.

FIG. 4B shows a detailed section of FIG. 4A.

FIG. 5A shows a two-dimensional image coordinate measurement in an aerial image.

FIG. 5B shows a detailed section of FIG. 5A.

FIG. 6 illustrates the data structure of the building model.

FIG. 7A shows the Constructive Solid Geometry model for a building as a component for extracting the building edges from the model for relative controls.

FIG. 7B shows the building in an aerial image.

FIG. 7C shows the extracted building lines.

FIG. 8A shows selected building edges as constraint lines.

FIG. 8B is a detailed section of FIG. 8A.

FIG. 8C is a detailed section of FIG. 8B showing more detail of the constraint lines.

FIG. 9 compares different building orthorectification using three control conditions, namely (col. a) 8 control points, (col. b) 232 ground control points and (col. c) 56 control points and 76 control lines.

### DETAILED DESCRIPTION

### I. Introduction

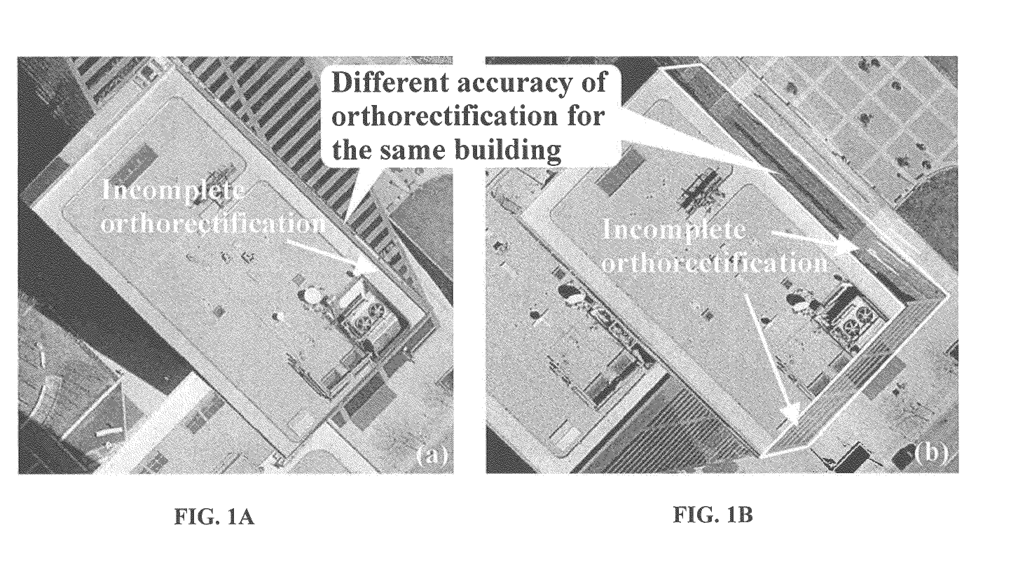

In attempting to create true orthoimages for high buildings, such as those over 75 m, it was discovered that some high buildings cannot be completely orthorectified into an upright and correct position, i.e., the building's walls can be viewed in the orthoimage (FIG. 1A). In examining the types of errors that might cause this incomplete orthorectification, the same building was orthorectified in two different aerial images using the same digital-building-model (DBM) and overall method. The building was completely orthorectified in one image, as shown in FIG. 1A, but not in the other image, as shown in FIG. 1B.

This revealed that the DBM, by itself, was not the cause. In other words, the incomplete orthorectification is probably directly caused by the inexact exterior orientation parameters or EOPs, because the conventional orthorectification algorithm largely depends on both the accuracy and the distribution of the ground control points or GCPs. Moreover, these GCPs are usually laid out in the ground. However, frequently in urban areas buildings may occlude other buildings and/or the buildings may occlude the ground; this can make the proper distribution of GCPs impractical. As a result, the orthorectified images might be incomplete.

Disclosed is a method to increase the accuracy of orthorectifying high buildings using relative constraint conditions. Section II focuses on the model establishment, and the experiment and accuracy analysis are in Section III.

### II. Model Establishment

### Perpendicular Control Condition

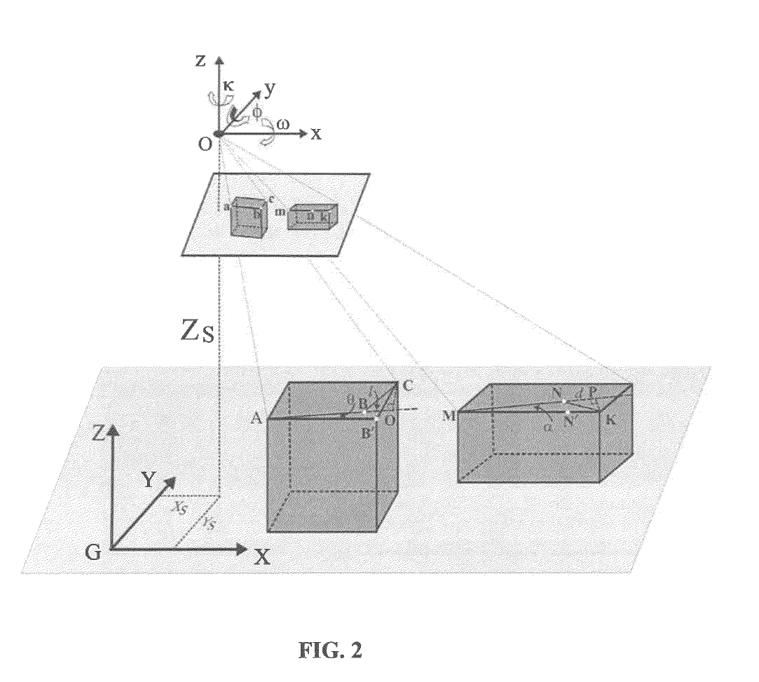

By way of preliminary example of the camera coordinate system shown in FIG. 2, if AB and BC are two edges of a flat house roof and that their corresponding edges in an image plane are ab and be. Suppose that the coordinates of A, B, and C are (X_{A}, Y_{A}, Z_{A}), (X_{B}, Y_{B}, Z_{B}), and (X_{C}, Y_{C}, Z_{C}) in the object coordinate system. For a flat-roof cube house, the heights (i.e., Z coordinates) of A, B, and C are the same, and the line segments AB and BC are perpendicular to each other.

If AB is not perpendicular to BC at an intersection angle θ, then B deviates from its correct position at B′. Draw a line from C to O and make the line CO perpendicular to AB′, as may be seen in FIG. 2. l denotes the distance of B and O, and may be expressed as:

$$\begin{matrix}l = ( {X}_{C} - {X}_{B} ) cos θ + ( {Y}_{C} - {Y}_{B} ) sin θ \\ = ( {X}_{C} - {X}_{B} ) \frac{( {X}_{B} - {X}_{A} )}{{s}_{AB}} + ( {Y}_{C} - {Y}_{B} ) \frac{( {Y}_{B} - {Y}_{A} )}{{s}_{AB}}\end{matrix} \qquad ( 3 )$$

where s_{AB} is the distance of the segment AB. Theoretically, the distance/should be zero. Thus, the differential form for equation (3) is:

$${l}_{0} + Δ l = [ ( {X}_{C} - {X}_{B} ) \frac{( {X}_{B} - {X}_{A} )}{{s}_{AB}} + ( {Y}_{C} - {Y}_{B} ) \frac{( {Y}_{B} - {Y}_{A} )}{{s}_{AB}} ] + \frac{1}{{s}_{AB}} [ ( {X}_{B} - {X}_{A} ) Δ {X}_{C} + ( {Y}_{B} - {Y}_{A} ) Δ {Y}_{C} + ( {X}_{B} - {X}_{C} ) Δ {X}_{A} + ( {Y}_{B } - {Y}_{C} ) Δ {Y}_{A} + ( {X}_{C} - 2 {X}_{B} + {X}_{A} ) Δ {X}_{B} + ( {Y}_{C} - 2 {Y}_{B} + {Y}_{A} ) Δ {Y}_{B} ] = 0. \qquad ( 4 )$$

Equation (4) may be re-written into a matrix form as follows:

$${[ \begin{matrix}{X}_{B} - {X}_{C} \\ {Y}_{B} - {Y}_{C} \\ {X}_{C} - 2 {X}_{B} + {X}_{A} \\ {Y}_{C} - 2 {Y}_{B} + {Y}_{A} \\ {X}_{B} - {X}_{A} \\ {Y}_{B} - {Y}_{A}\end{matrix} ]}^{T} [ \begin{matrix}Δ {X}_{A} \\ Δ {Y}_{A} \\ Δ {X}_{B} \\ Δ {Y}_{B} \\ Δ {X}_{C} \\ Δ {Y}_{C}\end{matrix} ] + [ ( {X}_{C} - {X}_{B} ) ( {X}_{B} - {X}_{A} ) + ( {Y}_{C} - {Y}_{B} ) ( {Y}_{B} - {Y}_{A} ) ] = 0. \qquad ( 5 )$$

Equation (5) is a perpendicular constraint condition, which describes line AB as being perpendicular to line BC on the X-Y plane. Similarly, if points B and C are on the plane X-Z or Y-Z, the perpendicular relative constraint conditions can be respectively expressed as:

$$\begin{matrix}{[ \begin{matrix}{X}_{B} - {X}_{C} \\ {Z}_{B} - {Z}_{C} \\ {X}_{C} - 2 {X}_{B} + {X}_{A} \\ {Z}_{C} - 2 {Z}_{B} + {Z}_{A} \\ {X}_{B} - {X}_{A} \\ {Z}_{B} - {Z}_{A}\end{matrix} ]}^{T} [ \begin{matrix}Δ {X}_{A} \\ Δ {Z}_{A} \\ Δ {X}_{B} \\ Δ {Z}_{B} \\ Δ {X}_{C} \\ Δ {Z}_{C}\end{matrix} ] + [ ( {X}_{C} - {X}_{B} ) ( {X}_{B} - {X}_{A} ) + ( {Z}_{C} - {Z}_{B} ) ( {Z}_{B} - {Z}_{A} ) ] = 0. & ( 6 ) \\ {[ \begin{matrix}{Y}_{B} - {Y}_{C} \\ {Z}_{B} - {Z}_{C} \\ {Y}_{C} - 2 {Y}_{B} + {Y}_{A} \\ {Z}_{C} - 2 {Z}_{B} + {Z}_{A} \\ {Y}_{B} - {Y}_{A} \\ {Z}_{B} - {Z}_{A}\end{matrix} ]}^{T} [ \begin{matrix}Δ {Y}_{A} \\ Δ {Z}_{A} \\ Δ {Y}_{B} \\ Δ {Z}_{B} \\ Δ {Y}_{C} \\ Δ {Z}_{C}\end{matrix} ] + [ ( {Z}_{C} - {Z}_{B} ) ( {Z}_{B} - {Z}_{A} ) + ( {Y}_{C} - {Y}_{B} ) ( {Y}_{B} - {Y}_{A} ) ] = 0. & ( 7 )\end{matrix}$$

The vector form for equation (5) may be rewritten as follows:

C₁\hat{X}₁+W₁=0 (8)

in which:

$${C}_{1} = {[ \begin{matrix}{X}_{B} - {X}_{C} \\ {Y}_{B} - {Y}_{C} \\ {X}_{C} - 2 {X}_{B} + {X}_{A} \\ {Y}_{C} - 2 {Y}_{B} + {Y}_{A} \\ {X}_{B} - {X}_{A} \\ {Y}_{B} - {Y}_{A}\end{matrix} ]}^{T} {\hat{X}}_{1} = [ \begin{matrix}Δ {X}_{A} \\ Δ {Y}_{A} \\ Δ {X}_{B} \\ Δ {Y}_{B} \\ Δ {X}_{C} \\ Δ {Y}_{C}\end{matrix} ]$$

$${W}_{1} = ( {X}_{C} - {X}_{B} ) ( {X}_{B} - {X}_{A} ) + ( {Y}_{C} - {Y}_{B} ) ( {Y}_{B} - {Y}_{A} )$$

### Collinear Constraint Condition

As may be seen in FIG. 2, if the line segments MN and NK are not collinear at an intersection angle of α, then:

$$\begin{matrix}d = ( {Y}_{K} - {Y}_{N} ) cos α + ( {X}_{K} - {X}_{N} ) sin α \\ = ( {Y}_{K} - {Y}_{N} ) \frac{( {X}_{N} - {X}_{M} )}{{S}_{MN}} + ( {X}_{K} - {X}_{N} ) \frac{( {Y}_{N} - {Y}_{M} )}{{S}_{MN}}\end{matrix} \qquad ( 9 )$$

where d is the distance between K and P. Similarly, its linearized equation and matrix form are, respectively:

$$\begin{matrix}{d}_{0} + Δ d = [ ( {Y}_{K} - {Y}_{N} ) \frac{( {X}_{N} - {X}_{M} )}{{S}_{MN}} + ( {X}_{K} - {X}_{N} ) \frac{( {Y}_{N} - {Y}_{M} )}{{S}_{MN}} ] + \frac{1}{{S}_{MN}} [ ( {Y}_{N} - {Y}_{M} ) Δ {X}_{K} + ( {X}_{N} - {X}_{M} ) Δ {Y}_{K} + ( {Y}_{N} - {Y}_{K} ) Δ {X}_{M} + ( {X}_{N} - {X}_{K} ) Δ {Y}_{M} + ( {Y}_{K} - 2 {Y}_{N} + {Y}_{M} ) Δ {X}_{N} + ( {X}_{M} - 2 {X}_{N} + {X}_{K} ) Δ {Y}_{N} ] = 0 & ( 10 ) \\ {[ \begin{matrix}{Y}_{N} - {Y}_{K} \\ {X}_{K} - {X}_{N} \\ {Y}_{K} - 2 {Y}_{N} + {Y}_{M} \\ {X}_{M} - 2 {X}_{N} + {X}_{K} \\ {Y}_{M} - {Y}_{N} \\ {X}_{N} - {X}_{M}\end{matrix} ]}^{T} [ \begin{matrix}Δ {X}_{M} \\ Δ {Y}_{M} \\ Δ {X}_{N} \\ Δ {Y}_{N} \\ Δ {X}_{K} \\ Δ {Y}_{K}\end{matrix} ] + [ ( {Y}_{K} - {Y}_{N} ) ( {X}_{N} - {X}_{M} ) + ( {X}_{K} - {X}_{N} ) ( {Y}_{N} - {Y}_{M} ) ] = 0. & ( 11 )\end{matrix}$$

Equation (11) is a collinear constraint condition, which describes line MN as collinear with line NK on the X-Y plane. Similarly, if the points M, N, and K are on the plane X-Z or Y-Z, the corresponding collinear constraint conditions are:

$$\begin{matrix}{[ \begin{matrix}{Z}_{N} - {Z}_{K} \\ {X}_{K} - {X}_{N} \\ {Z}_{K} - 2 {Z}_{N} + {Z}_{M} \\ {X}_{M} - 2 {X}_{N} + {X}_{K} \\ {Z}_{M} - {Z}_{N} \\ {X}_{N} - {X}_{M}\end{matrix} ]}^{T} [ \begin{matrix}Δ {X}_{M} \\ Δ {Z}_{M} \\ Δ {X}_{N} \\ Δ {Z}_{N} \\ Δ {X}_{K} \\ Δ {Y}_{K}\end{matrix} ] + [ ( {Z}_{K} - {Z}_{N} ) ( {X}_{N} - {X}_{M} ) + ( {X}_{K} - {X}_{N} ) ( {Z}_{N} - {Z}_{M} ) ] = 0. & ( 12 ) \\ {[ \begin{matrix}{Z}_{N} - {Z}_{K} \\ {Y}_{K} - {Y}_{N} \\ {Z}_{K} - 2 {Z}_{N} + {Z}_{M} \\ {Y}_{M} - 2 {Y}_{N} + {Y}_{K} \\ {Z}_{M} - {Z}_{N} \\ {X}_{N} - {X}_{M}\end{matrix} ]}^{T} [ \begin{matrix}Δ {Y}_{M} \\ Δ {Z}_{M} \\ Δ {Y}_{N} \\ Δ {Z}_{N} \\ Δ {Y}_{K} \\ Δ {Y}_{K}\end{matrix} ] + [ ( {Z}_{K} - {Z}_{N} ) ( {Y}_{N} - {Y}_{M} ) + ( {Y}_{K} - {Y}_{N} ) ( {Z}_{N} - {Z}_{M} ) ] = 0. & ( 13 )\end{matrix}$$

Equation (11) may be written in vector form as follows:

C₂\hat{X}₂+W₂=0 (14)

(i.e., with equations (12) and (13) being similar), in which:

$${C}_{2} = {[ \begin{matrix}{Z}_{N} - {Z}_{K} \\ {Y}_{K} - {Y}_{N} \\ {Z}_{K} - 2 {Z}_{N} + {Z}_{M} \\ {Y}_{M} - 2 {Y}_{N} + {Y}_{K} \\ {Z}_{M} - {Z}_{N} \\ {X}_{N} - {X}_{M}\end{matrix} ]}^{T} {\hat{X}}_{2} = [ \begin{matrix}Δ {Y}_{M} \\ Δ {Z}_{M} \\ Δ {Y}_{N} \\ Δ {Z}_{N} \\ Δ {Y}_{K} \\ Δ {Y}_{K}\end{matrix} ]$$

$${W}_{2} = ( {Z}_{K} - {Z}_{N} ) ( {Y}_{N} - {Y}_{M} ) + ( {Y}_{K} - {Y}_{N} ) ( {Z}_{N} - {Z}_{M} )$$

With reference to FIG. 2, if points A, B, and C and their corresponding imaged points a, b, and c are simultaneously GCPs, this means that one perpendicular or collinear constraint condition will add six additional unknown parameters (i.e., ΔXA, ΔYA, ΔZA, ΔXB, ΔYB, ΔZB for perpendicular constraint). Thus, equation (2) may be extended into:

V=AT+B\hat{X}−L (15)

where T=(ψωκX_{S}Y_{S}Z_{S})^{T}, \hat{X}=(ΔX_{A}ΔY_{A}ΔZ_{A}ΔX_{B}ΔY_{B}ΔZ_{B}ΔX_{M}ΔY_{M}ΔZ_{M}ΔX_{N}ΔY_{N}ΔZ_{N})^{T}, A and B are coefficient matrices, and V and L are similar to that in equation (2).

Combining equations (8), (14), and (15), produces the following:

$$\{ \begin{matrix}V = AT + B \hat{X} - L \\ {C}_{1} {\hat{X}}_{1} + {W}_{1} = 0 \\ {C}_{2} {\hat{X}}_{2} + {W}_{2} = 0\end{matrix} \qquad ( 16 )$$

Further, equation (16) may be rewritten as follows:

$$\{ \begin{matrix}V = D δ X - L \\ {C}_{x} δ X + {W}_{x} = 0\end{matrix} \qquad ( 17 )$$

in which Cₓ=(C₁C₂)^{T}, Wₓ=(W₁W₂)^{T}, D=(A|B), and δX=(ΔψΔωΔκΔX_{S}ΔY_{S}ΔZ_{S}ΔX_{A}ΔY_{A}ΔZ_{A} . . . ΔX_{N}ΔY_{N}ΔZ_{N})^{T}. With the least squares establishment method of reference Lawson (1995), equation (17) may be written as:

Φ=V^{T}V+2Kₛ^{T}(CₓδX+Wₓ)

The corresponding normal equation is

$$\{ \begin{matrix}{D}^{T} D δ X + {C}_{x}^{T} {K}_{s} + {D}^{T} L = 0 \\ {C}_{x} δ X + 0 {K}_{s} + {W}_{x} = 0\end{matrix} \qquad ( 18 )$$

where Kₛ is an introduced unknown matrix. If the number of the total observation equations is m, Kₛ is an m×1 matrix, i.e., Kₛ=(K_{S1}, K_{S2}, . . . , K_{Sm})^{T}. By letting N_{dd}=D^{T}D, equation (18) may then be rewritten as:

$$( \begin{matrix}{N}_{dd} & {C}_{x}^{T} \\ {C}_{x} & 0\end{matrix} ) ( \begin{matrix}δ X \\ {K}_{s}\end{matrix} ) + ( \begin{matrix}{D}^{T} L \\ {W}_{x}\end{matrix} ) = 0 \qquad ( 19 )$$

The solution of unknown parameters would then be:

$$\begin{matrix}\{ \begin{matrix}δ X = - ( {Q}_{11} {D}^{T} L + {Q}_{12} {W}_{x} ) \\ {K}_{s} = - ( {Q}_{21} {D}^{T} L + {Q}_{22} {W}_{x} )\end{matrix} \\ where \text{:} & ( 20 ) \\ {( \begin{matrix}{N}_{dd} & {C}_{x}^{T} \\ {C}_{x} & 0\end{matrix} )}^{- 1} = ( \begin{matrix}{Q}_{11} & {Q}_{12} \\ {Q}_{21} & {Q}_{22}\end{matrix} ) & ( 21 )\end{matrix}$$

Equation (20) is a mathematical model suitable for orthorectification. As shown, this model combines the building relative controls and the traditional ground point control. Thus, a higher accuracy of orthoimage can be achieved.

In conventional photogrammetry, the number and distribution of GCPs significantly impact the accuracy of orthorectification. Other factors affect the accuracy of orthorectification, such as the building size, length, and width of buildings, and these probably similarly impact the accuracy of the present method. As shown in FIG. 2, the longer the line AB, the smaller the error. On the other hand, the relief displacements caused by high buildings occur along radial lines from the nadir point. Thus, the relief displacements are zero from imaged objects at the nadir point, and increase with increased radial distances from the nadir.

### III. Experiments and Analyses

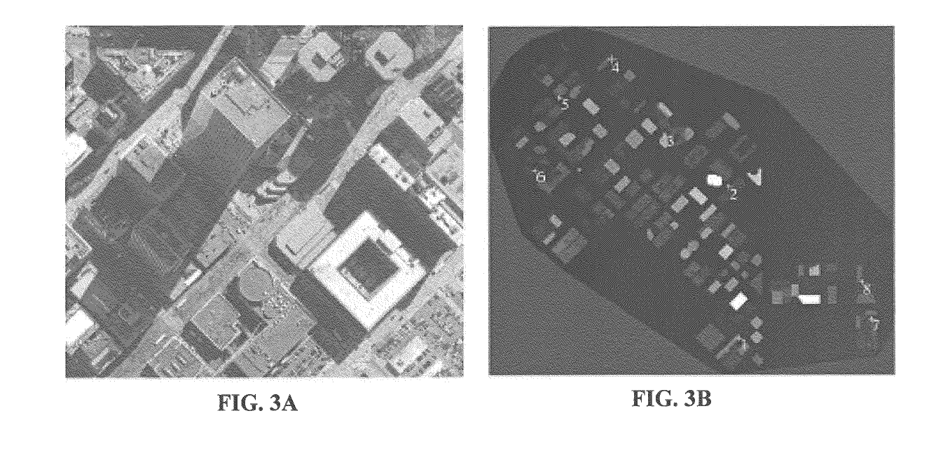

A description of experimental data may be found in reference G. Zhou, et al. (2005). The experimental urban location was downtown Denver, Colo. In Denver the highest building is 125 m, and there are many others at around 100 m. Six original aerial images were acquired from two flight strips using an RC30 aerial camera at a focal length of 153.022 mm. The flying height was approximately 1650 m above the mean ground elevation of the imaged area. The aerial photos were originally recorded on film and later scanned into digital format at a pixel resolution of 25 μm. A part of the scanned aerial images is shown in FIG. 3A. FIG. 3B shows the two dimensional (or 2-D) representation of the digital surface model (DSM).

### Control Information

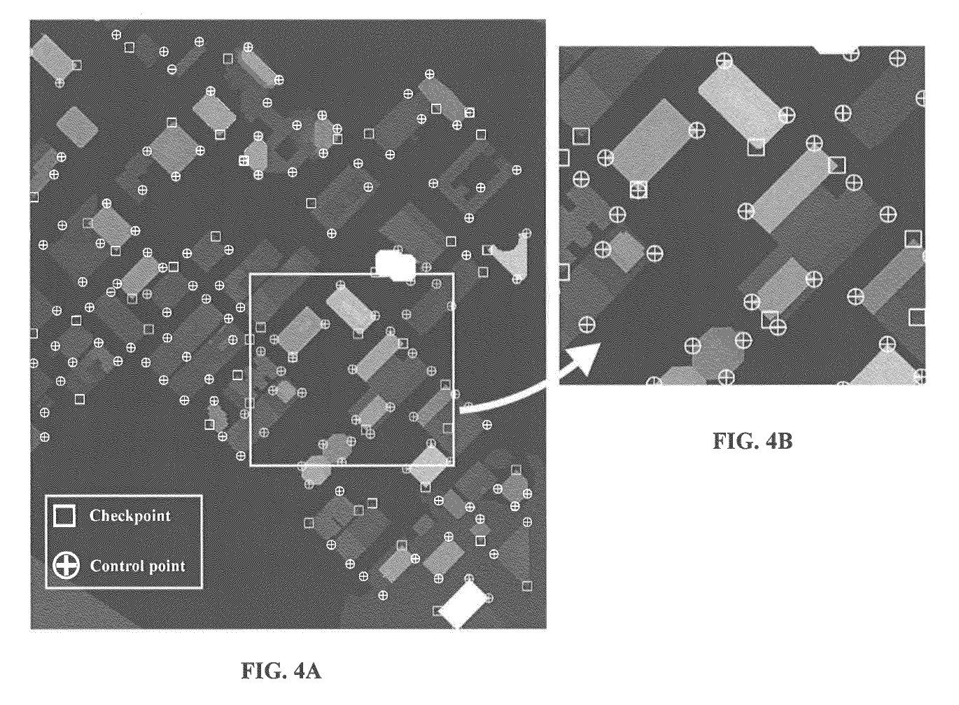

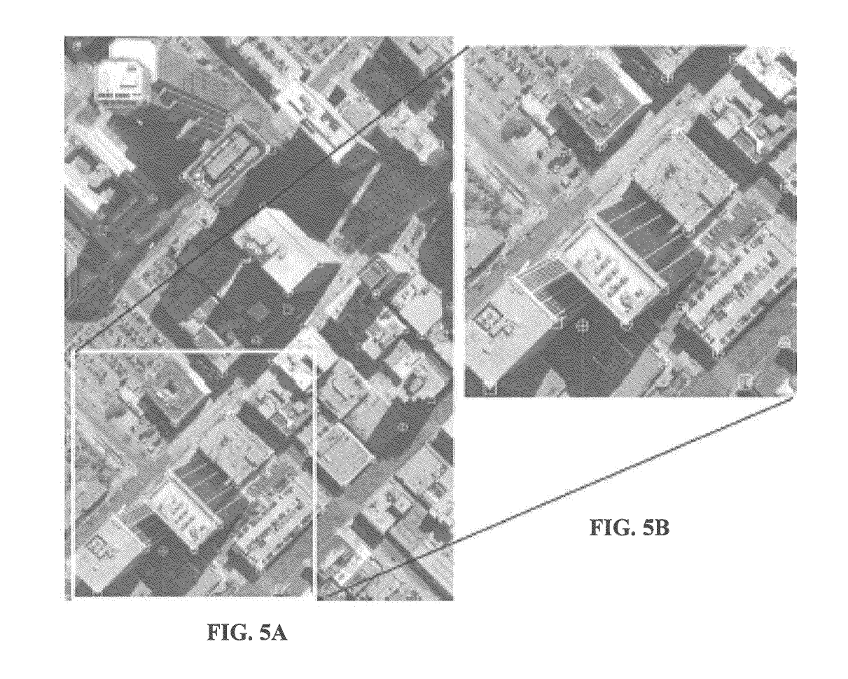

232 GCPs (i.e., 3-Dimensional coordinates) from the DBM were manually measured using Erdas/Imagine. The distribution of these GCPs covered an area of the entire downtown of Denver (FIGS. 4A & 4B). The measurement accuracy of the GCPs is approximately 1.48 pixels in x-direction and 1.27 pixels in y-direction, on average. The corresponding 2-D image coordinates were measured from the original aerial images using the following method (FIGS. 5A & 5B). FIG. 5A shows a two-dimensional image coordinate measurement in an aerial image. FIG. 5B is a detail of a section of the 2D image of FIG. 5A. First, a few (e.g., eight) GCPs were selected, including their 3-D and 2-D coordinates, and then EOPs were calculated for the aerial image using space intersection. With the calculated EOPs, all other GCPs were back-projected onto the aerial image to obtain the approximate position in the aerial image plane. The precise locations (i.e., 2-D image coordinates) were obtained by manually adjusting all these points in a magnified sub-window. The measurement accuracy of the 2-D image coordinates is a subpixel level.

In addition to the 232 GCPs, also measured were 89 checkpoints from the DBM to evaluate the accuracy of finally orthorectified image. Also, all the checkpoints are at corners of the buildings. The measurement accuracy is consistent with the GCPs (FIG. 4A & FIG. 4B).

### C. Constraint Line Extraction

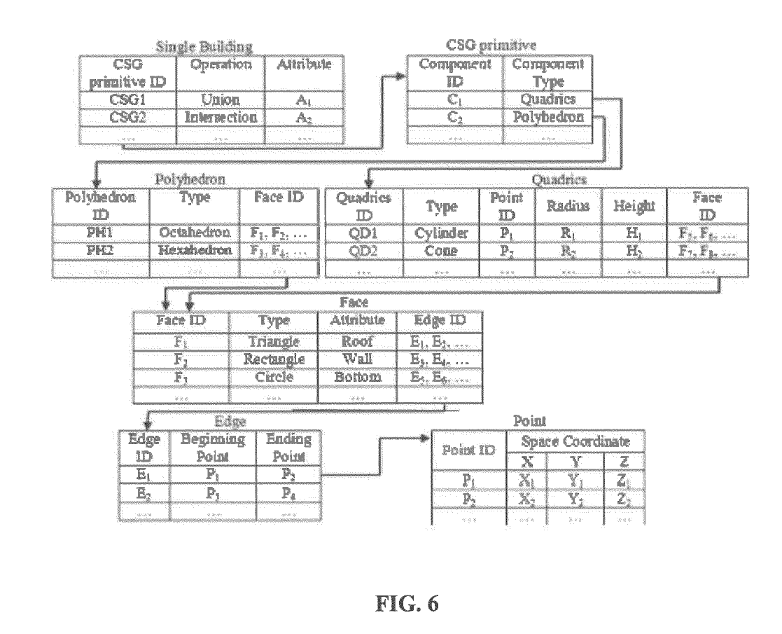

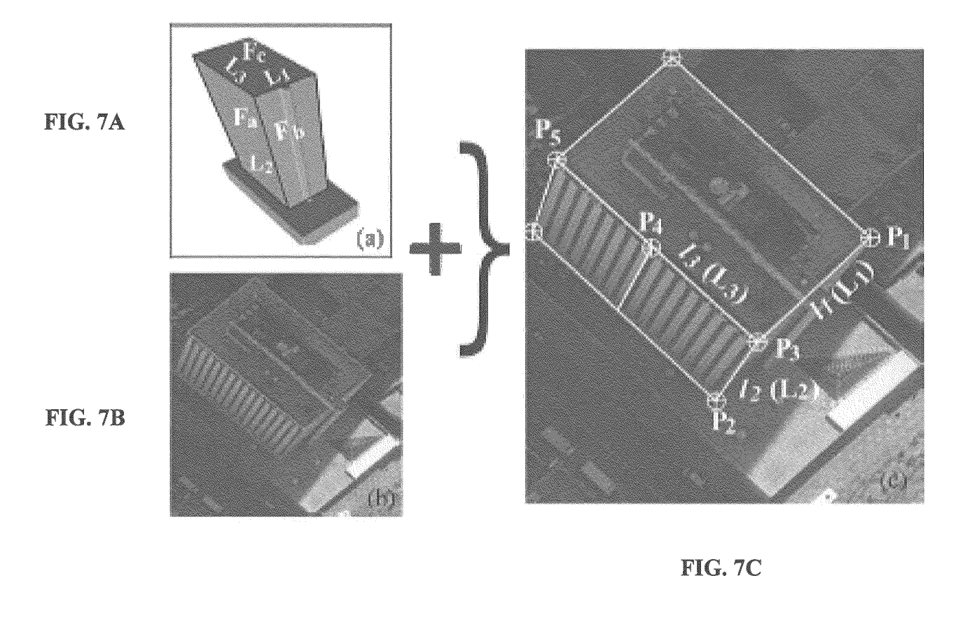

With the measured GCPs, the corresponding lines to be taken as constraint controls were simultaneously extracted. In this experiment, the model of describing each building was realized by using a parameterized constructive solid geometry (or CSG) method of reference W. Xie, et al. (2006). In this model, each element of CSG primitive was assigned with its properties, such as wall, roof, bottom, etc., and each building model has already contained its geometric topology, which describes the relationship of the building edges (FIG. 6). Thus, the characteristics of topology can automatically be transferred into the relative controls. In other words, the relationship describing edges of each building, such as perpendicularity and collinearity, can be transformed into equations (8) and/or (14). For example, in FIG. 7C, the faces Fa, Fb, and Fc; the edges L₁, L₂, and L₃; and their attributes are described in the CSG model. From the attributes of face data structure, L₁ and L₃ are automatically recognized as the edges of roofs, and L₂ as the edge of wall. On the other hand, the control points P₁, P₃, and P₅ are extracted, and they can be automatically constructed lines l₁, l₂, and l₃. When the L₁, L₂, and L₃ are back-projected onto the original aerial image, L₁, L₂, and L₃, whose topographic relationships have been described in the CSG model, will be matched with the lines l₁, l₂, and l₃, respectively. Thus, the attributes (e.g., edges of roof and edges of wall) and topographic relationships (i.e., perpendicularity) of l₁, l₂, and l₃ can be inherited from L₁, L₂, and L₃. Thus, l₁ and l₃ are edges in the roof, and l₂ is a vertical line in the wall. Also, l₂ is perpendicular to l₁ and l₃; and l₁ is also perpendicular to l₃. Thus, when l₁⊥l₃, (5) would be applied to construct a perpendicular relative control condition (equation) by replacing A, B, and C by P₅, P₃, and P₁ (see FIG. 7C).

Similarly, when point P₄ was measured on the line l₃, P₃, P₄, and P₅ should theoretically lie on a straight line of the building roof. Thus, a collinear constraint condition (see equation (14)) may be constructed by replacing M, N, and K by P₅, P₄, and P₃ (see FIG. 7C).

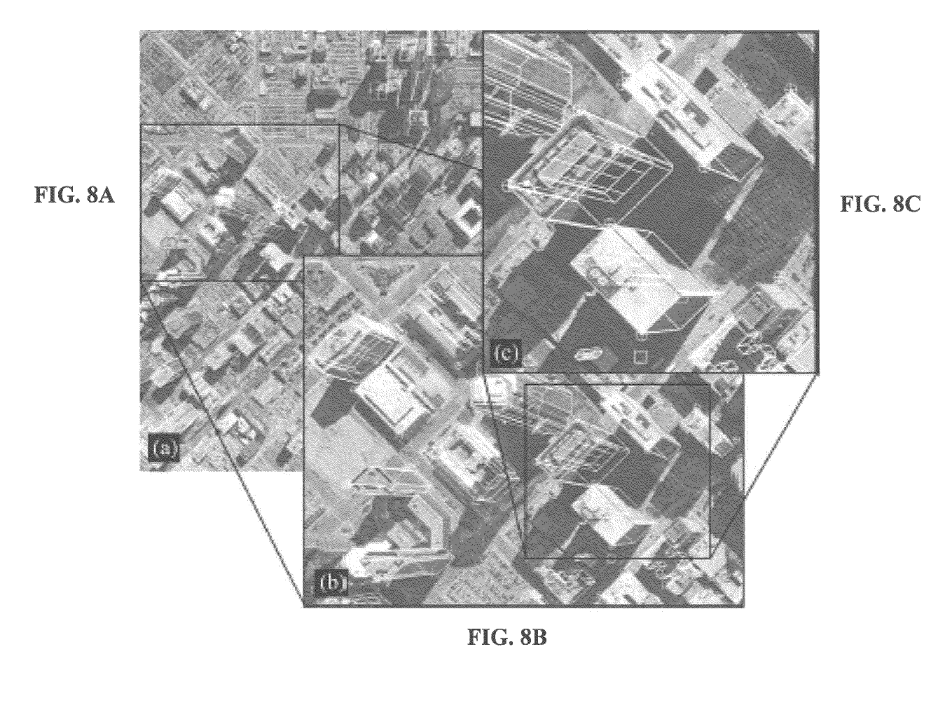

In this experiment, 106 buildings were back-projected onto the original aerial image. Seventy-six well-distributed lines were selected as relative controls. FIGS. 8A, 8B and 8C shows these selected geometric control lines, in which the projected model wire lines were rendered with transparent mode, so that the occluded parts can be seen.

### D. Accurate Comparison

Orthorectification was conducted through three methods. Method 1 only employed 8 GCPs; Method 2 used 232 GCPs; and Method 3 (an embodiment of the present method) employed 76 relative control lines and 56 GCPs. The IOPs were precisely calibrated and provided as shown in Table I. The EOPs were determined by space intersection, in which the three types of control data are employed. The results and accuracy are listed in Table II. As shown in Table II, our method has the highest accuracy at standard deviation of 0.12 pixel.

TABLE I
IOP

| Focal | | | | | |
|---|---|---|---|---|---|
| Length | Principal Point (mm) | | Distortion parameter | | |
| (mm) | x₀ | y₀ | k₁ | p₁ | p₂ |
| 153.022 | 0.002 | −0.004 | 0.2076 × | −0.1142 × | 0.1982 × |
| | | | 10⁻⁴ | 10⁻⁶ | 10⁻⁶ |

TABLE II
ACCURACY COMPARISON OF THE THREE METHODS FOR
THE EOP DETERMINATION

| | | Exterior Orientation Parameter | | | | | | |
|---|---|---|---|---|---|---|---|---|
| Methods | GCPs | Φ (arc) | ω (arc) | κ (arc) | Xₛ (ft) | Yₛ (ft) | Zₛ (ft) | δ_{σ} (pixel) |
| M1 | 8 pts | 0.0104 | 0.0158 | −1.5503 | 3143007.3 | 1696340.4 | 9032.0 | 0.65 |
| M2 | 232 pts | −0.0025 | −0.0405 | −1.5546 | 3143041.4 | 1696562.6 | 9070.7 | 0.49 |
| M3 | 56 pts + | −0.0016 | −0.0298 | −1.5538 | 3143040.6 | 1696520.9 | 9072.3 | 0.12 |
| | 76 lines | | | | | | | |

After the aforementioned three groups of EOPs were determined, the orthoimages were generated using the procedures described in reference G. Zhou, et al. (2002). The following two methods were employed to compare the accuracy of the three orthorectified images (orthoimages).

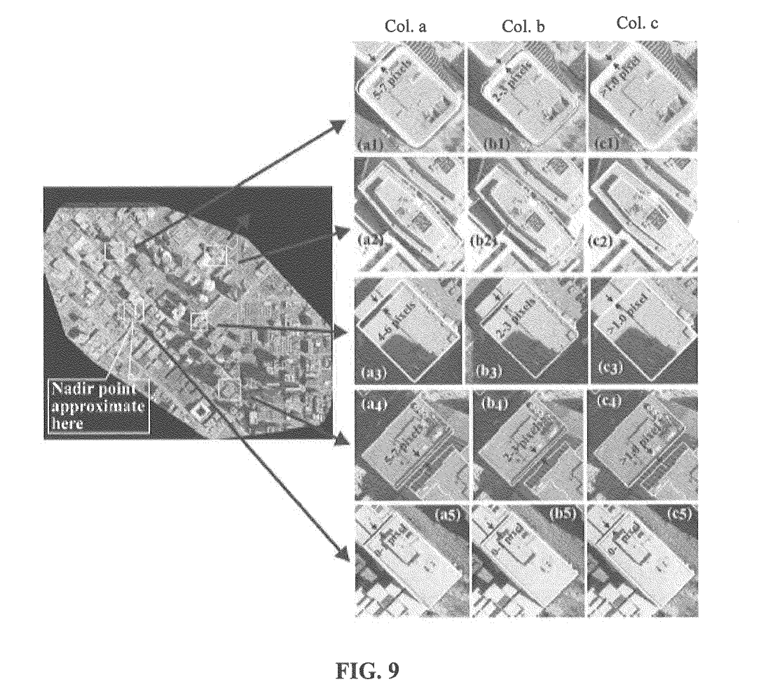

Visual check: The wire lines derived from the DBM model, which were taken as the “true” value, were superimposed onto the three orthorectified building roofs. Four orthorectified buildings with different heights and at different locations were selected for visually checking their achievable accuracy (FIG. 9, Col a, b, c). As shown, there are significant offsets between the building wire lines and the building edges in the orthoimage generated by Method 1. The average deviations for the four buildings were approximately 15 and 10 pixels along x- and y-directions. However, the average offsets from this embodiment of the present method were only 1.0-1.5 pixels in both x and y-directions. The results demonstrate that the accuracy of orthoimage generated by this embodiment has been greatly increased.

Checkpoint check: Eighty-nine checkpoints were employed to evaluate the absolute accuracy of the orthoimages orthorectified by three methods. The checkpoints were located in the corners of a building and were considered as a “true” value. The coordinates corresponding to the checkpoints in the three orthoimages were measured. The average deviations in both x- and y-directions are listed in Table III. As shown in Table III, the offsets from Methods 1 and 2 have approximately 3-5 and 2-4 ft, respectively, whereas 0.5-1.0 ft from the present method. The results again demonstrated that our method can significantly improve the accuracy of the generated orthoimage.

TABLE III
ACCURACY COMPARISON OF ORTHORECITFIED IMAGE

| | | |
|---|---|---|
| Method 1 | Method 2 | Our Method |
| (feet) | (feet) | (feet) |

| | ΔX | ΔY | ΔX | ΔY | ΔX | ΔY |
|---|---|---|---|---|---|---|
| Mean | 3.621 | 4.874 | 2.918 | 3.977 | 0.78 | 1.125 |

As mentioned earlier, the relief displacements caused by high buildings occur along radial lines from the nadir point, which means that the relief displacements are zero for imaged objects at the nadir point and increase with increased radial distances from the nadir. In order to examine how much the present method could improve the accuracy for the marginal and central objects, the errors for the margin and central orthoimage may be measured and it was found that the this method could improve the accuracy of orthoimaging approximately 5-7 ft for those objects in the image margin, but approximately 0-1 pixel for those high objects surrounding the nadir point (see FIG. 9).

### IV. Alternate Embodiments

An alternate embodiment, disclosed in the format of a claim, is as follows. What is claimed is a method of orthorectification of high-resolution (e.g., 6 inch or one foot) aerial images or photographs; selecting at least two corners at spatial locations on buildings to form geometric constrain controls; and applying a digital building model to orthorectify the building image at upright and correct position.

Another alternate embodiment, disclosed in the format of a claim, is as follows. What is claimed is a system of orthorectification comprising an imaging device adapted for capturing a plurality of images from at least one predetermined elevation, the plurality of images including at least one building having a plurality of corners, a recording device coupled with the imaging device for storing data from the plurality of images in a database, a processing device coupled with the database, the processor for selecting at least two corners at spatial locations on the at least one building to form geometric constrain controls; and applying a digital building model to orthorectify the building image at an upright and correct position.

Another alternate embodiment, disclosed in the format of a claim, is as follows. What is claimed is a computer readable medium storing a computer program product for orthorectifying a first image of at least one building having a plurality of corners using a plurality of images, the computer readable medium comprising: a computer program code for receiving and storing data from an imaging device, the data representing the plurality of images; a computer program code for selecting at least two corners at spatial locations on the at least one building; a computer program code for forming geometric constrain controls based on the plurality of corners; and a computer program code for applying a digital building model to orthorectify the first image with the building at an upright and correct position.

### V. General Alternatives

This contemplated method and arrangement may be achieved in a variety of configurations. While there has been described what are believed to be the preferred embodiment of the present invention, those skilled in the art will recognize that other and further changes and modifications may be made thereto without departing from the spirit of the invention, and it is intended to claim all such changes and modifications as fall within the true scope of the invention.

What is claimed is:

1. A method of differential orthorectification of a high-resolution aerial image taken at a known height, wherein at least a portion of the image depicts at least one structure, the method comprising:
(a) selecting at least two spatial locations on the portion of the image depicting the at least one structure, wherein the spatial locations correspond to points on the at least one structure in which edges of the structure are either perpendicular or collinear;
(b) forming at least two geometric constraint controls based on the at least two spatial locations using a digital building model; and
(c) applying the at least two geometric constraint controls to the image in order to orthorectify the portion of the image depicting the at least one structure into an upright and correct position.

2. The method of claim 1, wherein a perpendicular geometric constraint control on the digital building model is expressed by C₁\hat{X}₁+W₁=0.

3. The method of claim 1, wherein a collinear geometric constraint control on the digital building model is expressed by C₂\hat{X}₂+W₂=0.

4. The method of claim 1, wherein:
the differential orthorectification is expressed by V=AT+B\hat{X}−L;
a perpendicular geometric constraint control on the digital building model is expressed by C₁\hat{X}₁+W₁=0;
a collinear geometric constraint control on the digital building model is expressed by C₂\hat{X}₂+W₂=0; and wherein
$$\{ \begin{matrix}δ X = - ( {Q}_{11} {D}^{T} L + {Q}_{12} {W}_{x} ) \\ {K}_{s} = - ( {Q}_{21} {D}^{T} L + {Q}_{22} {W}_{x} )\end{matrix} \\ where \text{:} {( \begin{matrix}{N}_{dd} & {C}_{x}^{T} \\ {C}_{x} & 0\end{matrix} )}^{- 1} = ( \begin{matrix}{Q}_{11} & {Q}_{12} \\ {Q}_{21} & {Q}_{22}\end{matrix} ) .$$

5. A system of orthorectification comprising:
an imaging device for acquiring at least one image from at least one predetermined elevation, wherein at least a portion of the image depicts at least one structure;
a memory;
a processor in communication with the imaging device and the memory;
the memory hosting a database and a software coupled with the processor for selecting at least two spatial locations on the portion of the image depicting the at least one structure, wherein the spatial locations correspond to points on the at least one structure in which edges of the structure are either perpendicular or collinear;
forming at least two geometric constraint controls based on the at least two spatial locations using a digital building model; and
applying the at least two geometric constraint controls to the image in order to orthorectify the portion of the image depicting the at least one structure into an upright and correct position.

6. The system of claim 5, wherein a perpendicular geometric constraint control on the digital building model is expressed by C₁\hat{X}₁+W₁=0.

7. The system of claim 5, wherein a collinear geometric constraint control on the digital building model is expressed by C₂\hat{X}₁+W₁=0.

8. The system of claim 5, wherein:
the differential orthorectification is expressed by V=AT+B\hat{X}−L;
a perpendicular geometric constraint control on the digital building model is expressed by C₁\hat{X}₁+W₁=0;
a collinear geometric constraint control on the digital building model is expressed by C₂\hat{X}₂+W₂=0; and wherein
$$\{ \begin{matrix}δ X = - ( {Q}_{11} {D}^{T} L + {Q}_{12} {W}_{x} ) \\ {K}_{s} = - ( {Q}_{21} {D}^{T} L + {Q}_{22} {W}_{x} )\end{matrix} \\ where \text{:} \\ {( \begin{matrix}{N}_{dd} & {C}_{x}^{T} \\ {C}_{x} & 0\end{matrix} )}^{- 1} = ( \begin{matrix}{Q}_{11} & {Q}_{12} \\ {Q}_{21} & {Q}_{22}\end{matrix} ) .$$

9. A computer readable medium storing a computer program product for orthorectifying a first image of at least one building having a plurality of corners using a plurality of images, the computer readable medium comprising:
(a) a computer program code for receiving and storing data from an imaging device, the data representing the plurality of images;
(b) a computer program code for selecting at least two corners at spatial locations on the at least one building; a computer program code for forming geometric constraint controls based on the plurality of corners; and
(c) a computer program code for applying a digital building model to orthorectify the first image with the building at an upright and correct position.

10. The computer readable medium of claim 9, wherein a perpendicular geometric constraint control on the digital building model is expressed by C₁\hat{X}₁+W₁=0.

11. The computer readable medium of claim 9, wherein a collinear geometric constraint control on the digital building model is expressed by C₂\hat{X}₂+W₂=0.

12. The computer readable medium of claim 9, wherein:
the differential orthorectification is expressed by V=AT+B\hat{X}−L;
a perpendicular geometric constraint control on the digital building model is expressed by C₁\hat{X}₁+W₁=0;
a collinear geometric constraint control on the digital building model is expressed by C₂\hat{X}₂+W₂=0; and wherein
$$\{ \begin{matrix}δ X = - ( {Q}_{11} {D}^{T} L + {Q}_{12} {W}_{x} ) \\ {K}_{s} = - ( {Q}_{21} {D}^{T} L + {Q}_{22} {W}_{x} )\end{matrix} \\ where \text{:} {( \begin{matrix}{N}_{dd} & {C}_{x}^{T} \\ {C}_{x} & 0\end{matrix} )}^{- 1} = ( \begin{matrix}{Q}_{11} & {Q}_{12} \\ {Q}_{21} & {Q}_{22}\end{matrix} ) .$$
